(19) United States
(12) Patent Application Publication
(10) Pub. No.: US 2008/0025827 A1
(43) Pub. Date: Jan. 31, 2008

(54) Basket apparatus for mounting wheel to vehicle

(76) Inventor: Hoon Son, Hwaseong-si (KR)

Correspondence Address: MORGAN, LEWIS & BOCKIUS LLP (SF), 2 PALO ALTO SQUARE, 3000 El Camino Real, Suite 700, PALO ALTO, CA, 94306, US

(21) Appl. No.: 11/604,612

(22) Filed: Nov. 27, 2006

(30) Foreign Application Priority Data
Jul. 4, 2006 (KR) 10-2006-0062352

(51) Int. Cl. B60B 29/00

(52) U.S. Cl. 414/426

(57) ABSTRACT

A basket apparatus for mounting a wheel to a vehicle comprises a base frame; an upper frame positioned above the base frame; lifting means vertically installed between the base frame and the upper frame to raise and lower the upper frame with respect to the base frame in a vertical direction; a moving unit positioned on the upper frame to receive a wheel; a horizontal guide for supporting the moving unit at an incline with respect to the upper frame to allow the moving unit to be slowly moved in a wheel mounting direction by its own weight; and moving unit returning means installed to return the moving unit, having moved toward a vehicle, in the direction opposite the wheel mounting direction.

### CROSS-REFERENCE TO RELATED APPLICATIONS

The present application is based on, and claims priority from, Korean Application Serial Number 10-2006-0062352, filed on Jul. 4, 2006, the disclosure of which is hereby incorporated by reference herein in its entirety.

### FIELD OF THE INVENTION

The present invention relates, in general, to a basket apparatus for mounting a wheel to a vehicle and, more particularly, to a technique for easily moving a wheel to a vehicle and thereby ensuring easy mounting of the wheel to the vehicle in a vehicle assembly line.

### BACKGROUND OF THE INVENTION

In a vehicle assembly line, a large number of vehicles must be quickly assembled. Therefore, in a wheel attachment process, a wheel must be quickly and precisely attached, so that a worker can easily conduct a wheel mounting

### SUMMARY OF THE INVENTION

Embodiments of the present invention provide a basket apparatus for mounting a wheel to a vehicle, which receives a wheel and quickly, precisely and safely moves the wheel to a mounting position of a vehicle when the vehicle to be fitted with the wheel is positioned in place, to allow a worker to easily mount the wheel to the vehicle.

A basket apparatus for mounting a wheel to a vehicle according to the present invention, comprises a base frame; an upper frame positioned above the base frame; lifting means vertically installed between the base frame and the upper frame to raise and lower the upper frame with respect to the base frame in a vertical direction; a moving unit positioned on the upper frame to receive a wheel; a horizontal guide for supporting the moving unit at an incline with respect to the upper frame to allow the moving unit to be slowly moved in the direction for wheel mounting the wheel by its own weight; and moving unit returning means installed to return the moving unit, having moved toward a vehicle, in the direction opposite the wheel mounting direction.

### BRIEF DESCRIPTION OF THE DRAWINGS

For a better understanding of the nature and objects of the present invention, reference should be made to the following detailed description with the accompanying drawings, in which:

FIG. 1 is a perspective-view illustrating a basket apparatus for mounting a wheel to a vehicle in accordance with an embodiment of the present invention;

FIG. 2 is a front view of FIG. 1;

FIG. 3 is a plan view of FIG. 1;

FIG. 4 is a right side view of FIG. 1; and

FIG. 5 includes six illustrations of the basket apparatus in use.

### DETAILED DESCRIPTION OF THE PREFERRED EMBODIMENTS

Reference will now be made in greater detail to a preferred embodiment of the invention, an example of which is illustrated in the accompanying drawings. Wherever possible, the same reference numerals will be used throughout the drawings and the description to refer to the same or like parts.

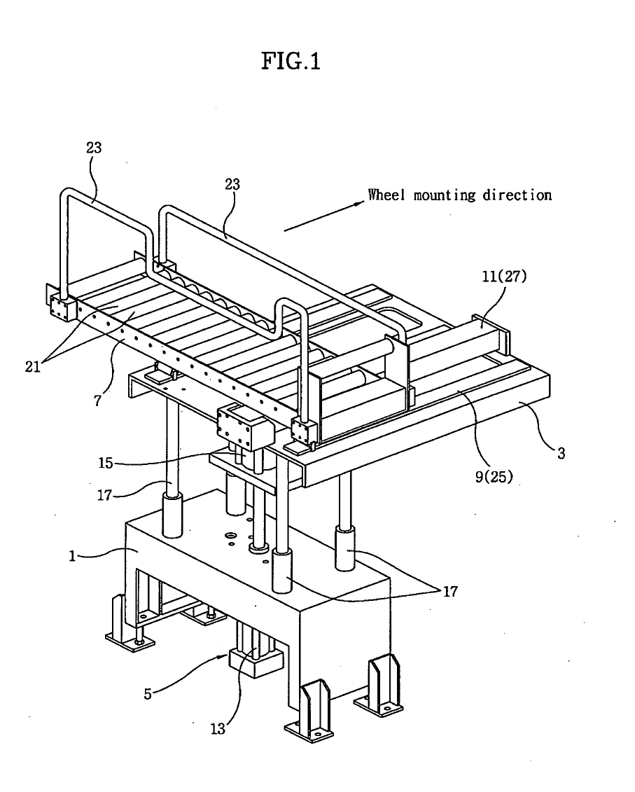

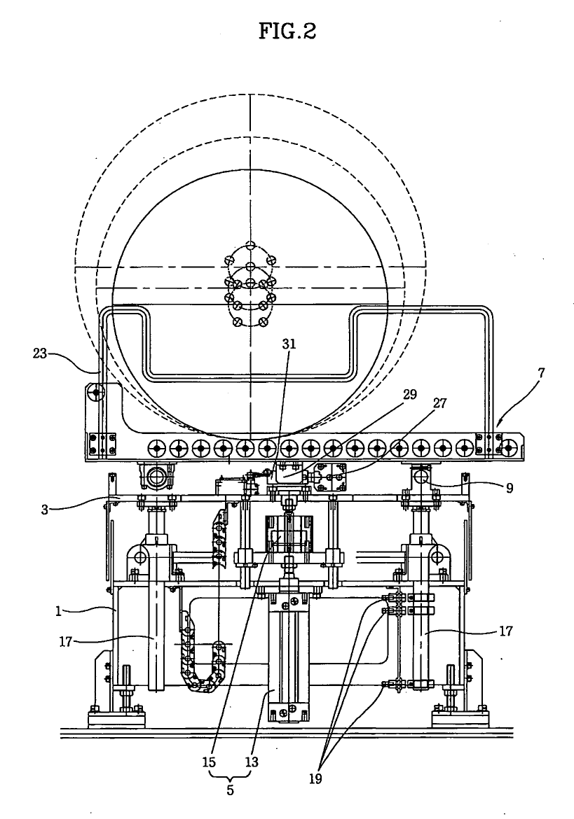

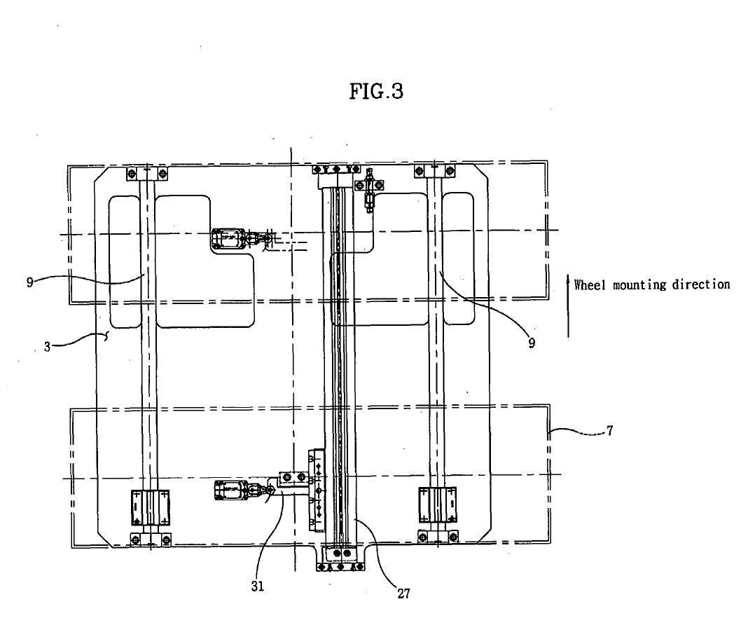

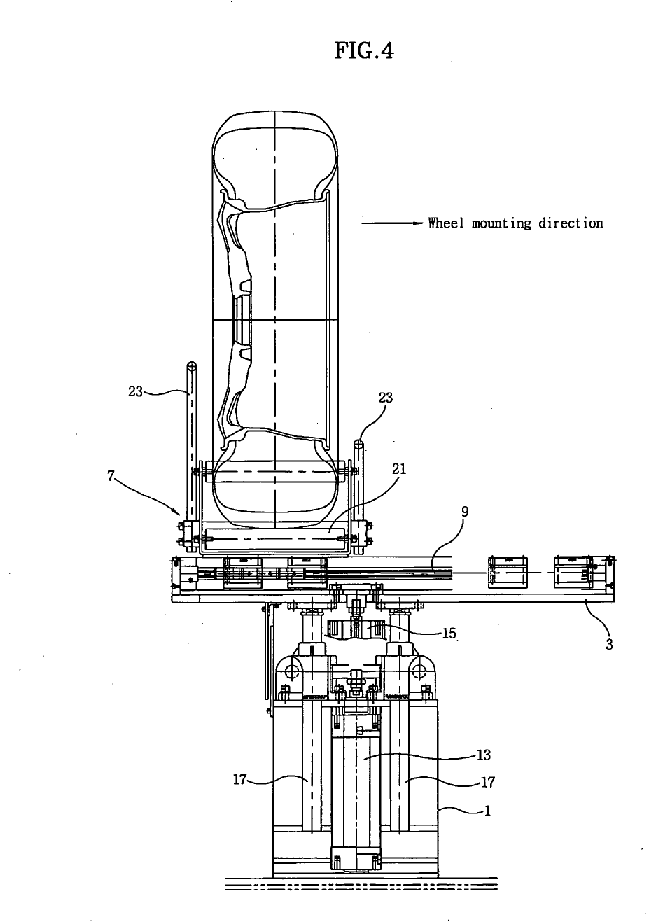

Referring to FIGS. 1 through 4, a basket apparatus for mounting a wheel to a vehicle in accordance with an embodiment of the present invention includes a base frame 1; an upper frame 3 positioned above the base frame 1; a lifting means 5 vertically installed between the base frame 1 and the upper frame 3 to raise and lower the upper frame 3 with respect to the base frame 1 in a vertical direction; a moving unit 7 positioned on the upper frame 3 to receive a wheel; a horizontal guide 9 for supporting the moving unit 7 at an incline with respect to the upper frame 3 to allow the moving unit 7 to be slowly moved in the wheel mounting direction by its own weight; and a moving unit returning means 11 installed to return the moving unit 7, having moved toward a vehicle, in the direction opposite the wheel mounting direction.

The base frame 1 is fixedly anchored to the floor of a factory at a position which is close to a vehicle to be fitted with a wheel. Vehicles are loaded on a bogie and sequentially and linearly pass through a wheel mounting process.

When a vehicle arrives at the wheel mounting location and stops, a basket apparatus for mounting a wheel to a vehicle according to the present invention is positioned beside each of four wheel hubs of the vehicle to be mounted with wheels.

In the present embodiment, the lifting means 5 comprises a first cylinder 13 having a cylinder body which is secured to the base frame, 1 a cylinder rod, and possessing a first operation stroke; and a second cylinder 15 having a cylinder body which is secured to the cylinder rod of the first cylinder 13 over the first cylinder 13 and a cylinder rod which is connected to the upper frame 3, the second cylinder 15 possessing an operation stroke which is shorter than that of the first operation stroke of the first cylinder 13.

Thus, two cylinders are installed up and down in series to have a double cylinder structure.

The lifting means 5 may include a plurality of lift guides 17 for guiding the upward and downward movement of the upper frame 3 with respect to the base frame 1, conducted by the first and second cylinders 13 and 15. A plurality of sensors 19 for sensing the upward and downward movements of the upper frame 3 are installed between the lift guides 17 and the base frame 1.

The lifting means 5 for raising and lowering the upper frame 3 may not comprise the first and second cylinders 13 and 15, but may comprise a single cylinder.

The reason why the two cylinders are installed in series as described above is to allow the apparatus to be adapted for wheels having a first size range by operating only the first cylinder 13, and for wheels having a second size range, different from the first size range, by operating only the second cylinder 15.

That is to say, when mounting wheels having sizes of 17, 18 and 19 inches, only the first cylinder 13 is operated to position the wheels on the center of a wheel hub, and when mounting wheels having sizes of 14, 15 and 16 inches, only the second cylinder 15 is operated to position the wheels on the center of a wheel hub.

Here, approximate centering is conducted to an extent such that a worker can easily mount a wheel to the wheel hub.

Of course, while the upper frame 3 can be raised and lowered in conformity with the size of a wheel by appropriately controlling the vertical movement distance of the upper frame 3 using only one cylinder as described above, in consideration of the usability and operational reliability of easily controllable cheap parts, it is preferable that the first and second cylinders 13 and 15 be adopted as in the present embodiment to define a double cylinder structure.

The moving unit 7 functions to receive a wheel from a wheel supply device positioned on one side of the present apparatus and delivers the wheel toward the vehicle by being raised and lowered through the upward and downward movement of the upper frame 3. The moving unit 7 includes a plurality of rollers 21 arranged such that the rotation axes of the rollers 21 are parallel to the wheel mounting direction, to support the lower end of the wheel; and a pair of guide bars 23 disposed to project upwards from both ends of the rollers 21 to thereby guide both side surfaces of the wheel.

The wheel is supplied onto the rollers 21 of the moving unit 7 by rolling it from the wheel supply device in an upright state. The rollers 21 function to help a worker easily handle the wheel.

Preferably, the guide bars 23 have a structure in which a urethane coating is applied around a steel pipe to prevent scratches from being formed by interference and contact with the wheel.

The horizontal guide 9 comprises a ball bearing type linear guide 25 installed between the moving unit 7 and the upper frame 3.

Due thereto, the horizontal guide 9 can reliably slide with extremely low frictional force in order to allow the upper frame 3 to be moved in the wheel mounting direction by its own weight.

The moving unit returning means 11 includes a rodless cylinder 27 installed on the upper frame 3 to extend in the wheel mounting direction; an engagement projection 29 downwardly projecting from the moving unit 7; and a dog 31 installed on the slider of the rodless cylinder 27 and formed to engage with the engagement projection 29 to thereby apply active force in the direction opposite the wheel mounting direction.

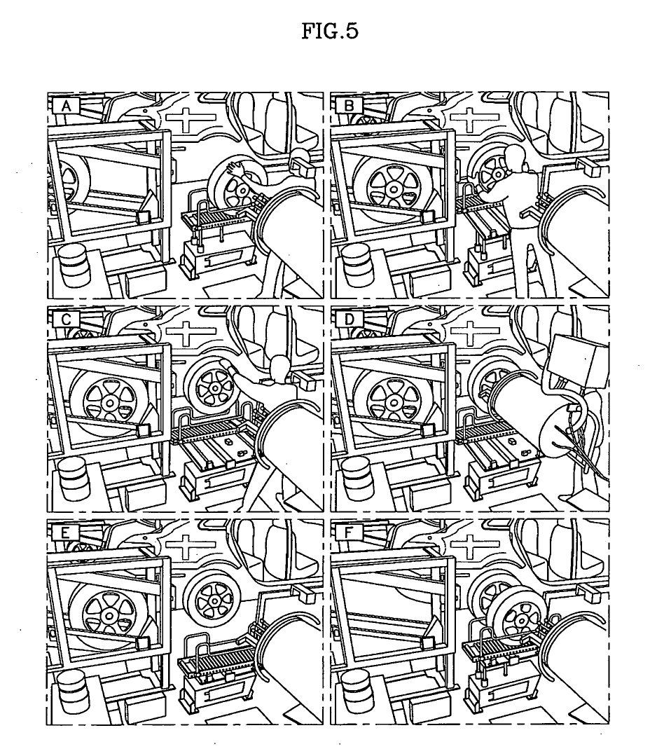

Hereafter, the operation of the basket apparatus for mounting a wheel to a vehicle according to the present invention, constructed as mentioned above, will be described with reference to FIG. 5.

The following descriptions will be given starting from the situation immediately after a vehicle to be fitted with a wheel is placed at a wheel mounting position and the wheel is supplied from the wheel supply device to the moving unit 7.

In the state in which the supply of the wheel to the moving unit 7 is completed, the slider of the rodless cylinder 27 is moved in the wheel mounting direction, and the moving unit 7 is slowly moved in the wheel mounting direction by its own weight along the linear guide 25 (A).

Due to the fact that the rodless cylinder 27 does not directly move the moving unit 7 in the wheel mounting direction, and instead the moving unit 7 is moved by its own weight as described above, collision and interference between the wheel and the wheel hub of the vehicle is prevented, and the wheel can be easily moved so that the wheel can be mounted to the wheel hub through simple manipulation by the worker.

The worker temporarily mounts the wheel to the wheel hub (B).

By operating the first and second cylinders 13 and 15, the upper frame 3 is lowered, and the moving unit 7 is lowered to be completely separated from the temporarily mounted wheel (C).

A nut runner approaches the wheel and completes the attachment of the wheel (D).

After the nut runner is withdrawn, the slider of the rodless cylinder 27 pulls the engagement projection 29 through the dog 31 so that the moving unit 7 is moved in the direction opposite the wheel mounting direction (E).

Namely, the rodless cylinder 27 allows the moving unit 7 to be easily returned without intruding into the work space of the worker.

After the upper frame 3 is raised by operating the first and second cylinders 13 and 15, a wheel is supplied from the wheel supply device so as to be placed in a standby state for mounting of the wheel to the next vehicle, whereby the cycle for mounting a wheel to a vehicle is completed.

As is apparent from the above description, the basket apparatus for mounting a wheel to a vehicle according to the present invention provides advantages in that the basket apparatus receives a wheel and quickly, precisely and safely moves the wheel to a mounting position to a vehicle when the vehicle to be mounted with the wheel is positioned in place, to allow a worker to easily mount the wheel to the vehicle, whereby assemblability and safety are improved, and the basket apparatus can be constructed to be easily applied to various kinds of vehicles.

While the foregoing description and drawing represent various embodiments of the present invention, it should be appreciated that the foregoing description should not be deemed limiting since additions, variations, modification, and substitutions may be made without departing from the spirit and scope of the present invention. It will be clear to one of skill in the art that the present invention may be embodied in other forms, structures, arrangements, proportions and using other elements, materials and components.

What is claimed is:

1. A basket apparatus for mounting a wheel to a vehicle, comprising:
a base frame;
an upper frame positioned above the base frame;
a lifting means vertically installed between the base frame and the upper frame to raise and lower the upper frame with respect to the base frame in a vertical direction;
a moving unit positioned on the upper frame;
a horizontal guide for supporting the moving unit at an incline with respect to the upper frame; and
a moving unit returning means installed to return the moving unit in a direction opposite the wheel mounting direction.

2. The basket apparatus as set forth in claim 1, wherein the horizontal guide further allows the moving unit to move in a wheel mounting direction by its own weight.

3. The basket apparatus as set forth in claim 1, wherein the base frame is fixedly anchored to a floor.

4. The basket apparatus as set forth in claim 1, wherein the lifting means comprises a single cylinder.

5. The basket apparatus as set forth in claim 1, wherein the lifting means comprises:
a first cylinder having a first cylinder body which is secured to the base frame, a first cylinder rod, and a possessing a first operation stroke; and
a second cylinder having a second cylinder body which is secured to the first cylinder rod of the first cylinder over the first cylinder and a second cylinder rod which is connected to the upper frame, and possessing a second operation stroke which is shorter than the first operation stroke of the first cylinder.

6. The basket apparatus as set forth in claim 1, wherein the lifting means comprises:
a first cylinder having a cylinder body which is secured to the base frame, a cylinder rod, and a possessing a first operation stroke;
a second cylinder having a cylinder body which is secured to a cylinder rod of the first cylinder over the first cylinder and a cylinder rod which is connected to the upper frame, and possessing an operation stroke which is shorter than that of the first cylinder; and
a plurality of lift guides for guiding raising and lowering of the upper frame.

7. The basket apparatus as set forth in claim 1, wherein the lifting means comprises:
a first cylinder having a cylinder body which is secured to the base frame, a cylinder rod, and a possessing a first operation stroke;
a second cylinder having a cylinder body which is secured to a cylinder rod of the first cylinder over the first cylinder and a cylinder rod which is connected to the upper frame, and possessing an operation stroke which is shorter than that of the first cylinder; and
a plurality of sensors installed between the lift guides and the base frame for sensing the raising and lowering of the upper frame.

8. The basket apparatus as set forth in claim 1, wherein the lifting means comprises:
a first cylinder having a cylinder body which is secured to the base frame, a cylinder rod, and a possessing a first operation stroke;
a second cylinder having a cylinder body which is secured to a cylinder rod of the first cylinder over the first cylinder and a cylinder rod which is connected to the upper frame, and possessing an operation stroke which is shorter than that of the first cylinder;
a plurality of lift guides for guiding raising and lowering of the upper frame; and
a plurality of sensors installed between the lift guides and the base frame for sensing the raising and lowering of the upper frame.

9. The basket apparatus as set forth in claim 1, wherein the moving unit comprises:
a plurality of rollers arranged such that rotation axes of the rollers are parallel to the wheel mounting direction, to support a lower end of the wheel.

10. The basket apparatus as set forth in claim 1, wherein the moving unit comprises:
a plurality of rollers arranged such that rotation axes of the rollers are parallel to the wheel mounting direction, to support a lower end of the wheel; and
a pair of guide bars disposed to project upwards from both ends of the rollers to thereby guide both side surfaces of the wheel.

11. The basket apparatus as set forth in claim 1, wherein the moving unit comprises:
a plurality of rollers arranged such that rotation axes of the rollers are parallel to the wheel mounting direction, to support a lower end of the wheel; and
a pair of guide bars disposed to project upwards from both ends of the rollers to thereby guide both side surfaces of the wheel;
the pair of guide bars being made of a steel pipe with a urethane coating.

12. The basket apparatus as set forth in claim 1, wherein the horizontal guide comprises a ball bearing type linear guide installed between the moving unit and the upper frame.

13. The basket apparatus as set forth in claim 1, wherein the moving unit returning means comprises:
a rodless cylinder installed on the upper frame to extend in the wheel mounting direction;
an engagement projection projecting downwards from the moving unit; and
a dog installed on a slider of the rodless cylinder and formed to engage with the engagement projection to thereby apply an active force in the direction opposite the wheel mounting direction.

14. A method for mounting a wheel to a vehicle using a basket apparatus, comprising:
a base frame;
an upper frame positioned above the base frame;
a lifting means vertically installed between the base frame and the upper frame to raise and lower the upper frame with respect to the base frame in a vertical direction;
a moving unit positioned on the upper frame;
a horizontal guide for supporting the moving unit at an incline with respect to the upper frame; and
a moving unit returning means installed to return the moving unit in a direction opposite the wheel mounting direction.

15. A method for mounting a wheel to a vehicle as set forth in claim 14 further comprising:
a first cylinder having a cylinder body which is secured to the base frame, a cylinder rod, and a possessing a first operation stroke;
a second cylinder having a cylinder body which is secured to a cylinder rod of the first cylinder over the first cylinder and a cylinder rod which is connected to the upper frame, and possessing an operation stroke which is shorter than that of the first cylinder;
wherein when mounting a wheel having a sizes of 17,18, or 19 inches, only the first cylinder is operated to position the wheel.

16. A method for mounting a wheel to a vehicle as set forth in claim 14 further comprising:
a first cylinder having a cylinder body which is secured to the base frame, a cylinder rod, and a possessing a first operation stroke;
a second cylinder having a cylinder body which is secured to a cylinder rod of the first cylinder over the first cylinder and a cylinder rod which is connected to the upper frame, and possessing an operation stroke which is shorter than that of the first cylinder;
wherein when mounting a wheel having a sizes of 14,15, or 16 inches, only the second cylinder is operated to position the wheel.

17. A system for mounting a wheel to a vehicle using a basket apparatus, comprising:
a base frame;
an upper frame positioned above the base frame;
a lifting means vertically installed between the base frame and the upper frame to raise and lower the upper frame with respect to the base frame in a vertical direction;
a moving unit positioned on the upper frame;
a horizontal guide for supporting the moving unit at an incline with respect to the upper frame; and
a moving unit returning means installed to return the moving unit in a direction opposite the wheel mounting direction.
